(19) United States
(12) Patent Application Publication
(10) Pub. No.: US 2003/0229704 A1
(43) Pub. Date: Dec. 11, 2003

(54) Indicating computers' right for using data files utilizing computer activities history

(76) Inventor: Mahdi Golestaneh, Tehran (IR)

Correspondence Address: MAHDI GOLESTANEH, NO. 17/1-DOLATSHAD GHARBI ST. - FARIDAFSHAR ST. -, DASTGERDI ST. - SHARIATI ST., TEHRAN, 1916615474, IR

(21) Appl. No.: 10/436,747

(22) Filed: May 14, 2003

Related U.S. Application Data
(60) Provisional application No. 60/385,740, filed on Jun. 5, 2002.

(30) Foreign Application Priority Data
Jun. 24, 2002 (AU) PS3109
May 25, 2002 (AU) PS2568

(51) Int. Cl. H04K 1/00; H04L 9/00; G06F 17/60; G06F 15/173; G06F 15/16

(52) U.S. Cl. 709/229; 705/59; 709/223

(57) ABSTRACT

This invention introduces new method for indicating computer right for using data files based on their activities. In this method every computer that have a log that match the registered log for concerned data file have right to use the data file.

### CROSS-REFERENCE TO RELATED APPLICATIONS

This application is entitled to the benefit of following applications:

U.S. Provisional Patent Application Ser. No.: 60/385,740 filed Jun. 5, 2002.

Australia Patent Application Ser. Nr: PS3109 filed Jun. 24, 2002.

Australia Patent Application Ser. Nr: PS2568 filed May. 25, 2002.

| | |
|---|---|
| FEDERALLY SPONSORED RESEARCH | Not Applicable |
| SEQUENCE LISTING OR PROGRAM | Not Applicable |

### BACKGROUND OF THE INVENTION

This invention is related to usage protection of data files\Licensing.

As a point, this invention can be compared with technique of using hardware ID as computer identity in copy protection systems. But With a different that in this invention, the ID can be moved from one computer to another.

This technique is being used widely in copy protection systems. An example of products that uses this method is Microsoft® Windows XP®. This method creates an identity for every computer based on the hardware devices installed on the computer (hardware ID). Software user should activate (register) the product to be able to use it. It means he should send hardware ID and product ID (PID) to the product publisher. PID mean every data that is unique for every legal copy of software to identify that legal copy (for example serial no#). Software publisher have a database that every PID has a cell on the database when a user sends this info, the publisher checks whether this PID has not been registered by other hardware ID in database, then if yes, publisher registers this PID with sent hardware ID and sent a key data to the user and user is able to use the software by entering this key. For avoiding from reinstallation of this software on another computer, this key is usable once and if the software reinstalled either on this computer or on another computer, it needs another key. Thus, every copy of software can be installed only on one computer.

Nevertheless, in this licensing method if user changes computer hardware the software is not more usable. Moreover, the user cannot move the software from one computer to another (floating licensing). In addition, users can cheat the software publisher by using a false hardware ID. For example, if two users want to use one copy of a product illegally and PID of that copy has been registered by first user's computer's hardware ID. If the second computer sends hardware ID of first computer at the software activation (usually by using a cracked copy of software) the software publisher assumes that the software is reinstalled on first computer, so publisher sends another key.

But, in this method which logs are being used for identifying computer by copying logs two computers cannot cheat the data files publisher even when they do not try to use that log for being verified at same times. Thanks to this specification, we can have powerful usage protection systems. An example of these usage protection systems that is cited as cross-reference applications is unbreakable for illegal use of pirated copies of operating systems and about other kinds of soft wares, a cracked (changed) copy of software cannot be distributed and is usable only on one computer. In addition, in this method moving the data files is possible.

### SUMMARY

The claimed invention is a new method for indicating a client computer ownership for using a data files. In this method every computer that have a file that matches the registered log for that data file have right to use the data file. The registered Log has been produced based on computers' activities who were the owners of that data files.

### DRAWINGS—FIGURES

FIG. 1 illustrates the method of determining a computer's right for using a data file.

FIG. 2 illustrates the contents of publisher's database (DB 50).

FIG. 3 illustrates relation between components of the sample copy protection system that uses the claimed method.

### DRAWINGS—REFERENCE NUMERALS

10. Participating server

20. Client computer reported log (cLog)

30. Registered log (rLog)

40. Data files or software publisher

50. Publisher's data-base for storing the registration info (DB)

### DETAILED DESCRIPTION

As shown in FIG. 1 in this method, computer should send log of a concerned activities to publisher 40 (computer reported log or cLog 20). Another source is informed from these activities and produces another log (registered log—rLog 30). By comparing the cLog 20 and rLog 30, it will indicated that the computer have required cLog 20. In this method, the cLog 20 is the ticket for using data file.

A sample copy protection system that uses above-described method is illustrated below.

In this software copy protection system, unauthorized users of software cannot connect to participating servers 10.

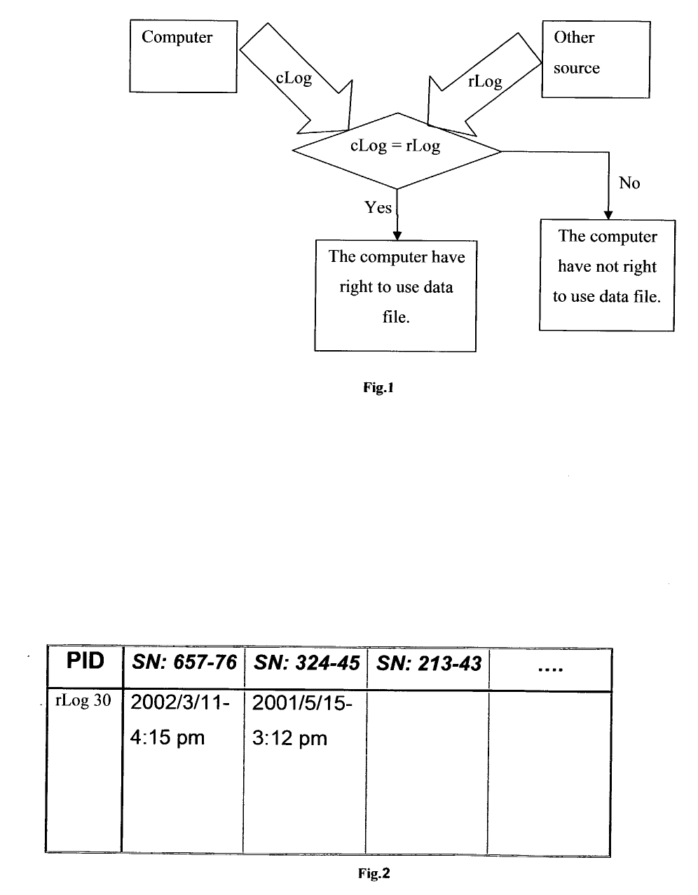

The software publisher 40 has a database (DB 50) that every copy of the product has one cell (FIG. 2). At beginning, the registered Logs (rLog 30) are empty. PID means every data that is unique for every legal copy of product to identify that legal copy (for example a serial number).

Every computer that connects to a participating server 10 on internet should send to the server 10 PID of the product that the usage protection system is protecting it (if it is installed on computer) and the cLog (the time of connection to previous server 10 that is reported by computer is called Computer reported Log or cLog 20 in this document). The cLog 20 is empty in first connection. When computer sent PID and cLog 20, the server forwards this data and the current connection time of computer to the server 10 to the publisher 40. Based on sent PID, The cell of this Product copy will be found in The DB 50 and publisher 40 checks whether the cLog 20 and registered Log (rLog 30) are same. If yes, the publisher 40 send permission to server 10 to allow the computer to access to the server 10 and puts the reported time via server 10 in rLog (FIG. 2). Computer should put this connection time in cLog 20, too.

Participating server means a server that participates in usage protection system and does not allow access of client computers without publisher 40 permission.

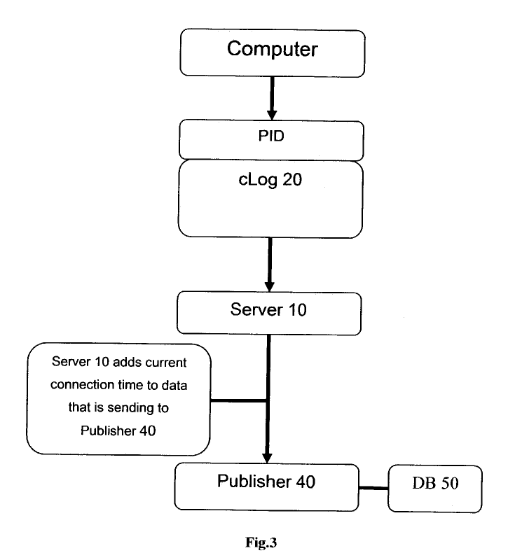

Next time that computer wants to connect to another participating server 10 or even this server 10, again, at first, the server 10 asks it to sends the time of its connection to previous server 10 (cLog 20) and PID. The server 10 sends current connection time and the sent data by computer to the publisher 40. Based on sent PID, publisher 40 refers to related PID's cell in DB 50 and checks if cLog 20 and rLog 30 are same. Then if yes, software publisher sends permission to server 10 for allowing the computer to access to the server 10. This time is replaced in rLog 30 in DB 50 that was related to that computer. Computer should put this time to cLog 20, too (FIG. 3). As mentioned above computer send cLog 20 in the first connection, too but it is empty in first connection. And publisher 40 checks this empty cLog 20 with rLog 30 and if the rLog 30 was empty, too, sends an allowance to server 10.

Times in rLog 30 and cLog 20 should be recorded based on same time-zone. The publisher 40 may ask the computer for date of connections, too.

What does it mean if the times were not same in cLog 20 and rLog 30 for one PID?

If the cLog 20 is empty it means that Product has been copied from first computer to another computer and at this time, it is the second computer that sends a new cLog 20. Second computer that have empty cLog 20 that does not match rLog 30 will not be allowed to connect to the server 10. The rLog 30 still matches with first computer's cLog 20.

What will happen if the second computer's user copies cLog 20 from first computer, along with the software?

If assume software is still installed on the first computer one of two computers that connect to a participating server 10 the time of this connection will be put in rLog 30 of that PID and the cLog 20 on this computer is updated, too. But the other computer still have the old cLog 20 that does not match the updated rLog 30, now. So one of computers that connects to a participating servers earlier (from time that the cLog 20 is copied) is allowed to connects to these servers 10 for ever, and the other computer is not able to connect to participating severs 10 until the pirated copy be uninstalled from it. It is not important which computer connects first, in every status, the license will remain for one computer.

If the first computer is uninstalled the software, by copying the cLog 20 from first computer, the second computer can use the software while it has permission to connect to the servers 10. The reason is that the first computer no more sends this PID and cLog 20. It is assured that the second computer have a cLog 20 that will matches the rLog 30. The first computer is still able to connect to the servers 10. In other word, moving the software is authorized but not copying.

It is noticeable that the computer has to do two operations to be able to connect to the servers 10:

1—storing the connections times to cLog 20 and keeping cLog 20 updated

2—Sending cLog 20 and PID to servers 10 for getting permission to connect to them.

If the system is using for protecting copies of more than one product when one or some of them is installed on a computer the computer is required by servers 10 to sends a separate cLog 20 for every one of these product. And when publisher 40 checks these cLogs 20 with related rLogs 30 the publisher will update the matched rLogs 30 with the current connection time of the computer.

If a copy of a product is licensed to more than one computer that product should has rLogs 30 in DB 50 as the number of permitted users.

One of this system's problems is when a computer does not send PID of software that the system is protecting it while it is installed on computer. Therefore, the publisher assumes that the concerned product is not installed on computer. Thus, allows the computer to connect to the servers 10. This problem is solved on another system but because the purpose of this application is only claiming the licensing method, which this system uses, the other system—that is another invention—is cited as cross-reference application)

Using this Method for other Purposes

This method can be used for purposes other than data files copy protection. For example identifying computers or in every case that the number of computers that are using a product or a service is important and should be controlled.

Activities that can be Used for Logging

The above-mentioned system uses time of connection to the servers as an activity for logging but logs can be produced based on history of every computer's activities, which a source other than the computer is informed of these computer's activities, too. This kind of computer activities can be online activities like times of connection to the sites or the name of connected servers or sites or time and date of connections to internet.

1. Method for indicating a computer's right for using a data file comprising:
(a) Producing a first signal based on history of said computer's activities that reported by said computer
(b) Producing a second signal based on history of computer's activities that reported by a source other than said computer
(c) Comparing said first signal with second signal.

2. Method for indicating a computer's right for using a data file comprising:
(a) receiving a signal from said computer
(b) Producing a second signal based on history of computers' activities, which were the authorized users of said data file.
(c) Comparing received signal with said second signal to indicate said computer's right for using said data file.
Whereby enforcing floating licenses is possible and said computer may copies some files from the computers, which they are the previous users of said data file to be able to send the required signal.
